(19) United States
(12) Patent Application Publication
(10) Pub. No.: US 2026/0135976 A1
(43) Pub. Date: May 14, 2026

(54) VEHICULAR SENSING SYSTEM WITH DOOR HAZARD DETECTION

(71) Applicant: Magna Electronics Inc., Auburn Hills, MI (US)

(72) Inventors: Jeremy J. Baca, Ann Arbor, MI (US); Naresh Ravuri, Novi, MI (US)

(21) Appl. No.: 19/370,970

(22) Filed: Oct. 28, 2025

Related U.S. Application Data
(60) Provisional application No. 63/717,933, filed on Nov. 8, 2024.

(51) Int. Cl. H04N 7/18; B60Q 9/00; B60R 1/12; B60R 1/25; G06V 20/58; G06V 20/59

(52) U.S. Cl. CPC H04N 7/181; B60Q 9/008; B60R 1/1207; B60R 1/25; G06V 20/58; G06V 20/597; B60R 2300/105; B60R 2300/8093

(57) ABSTRACT

A vehicular sensing system includes a camera that views at least a portion of an interior cabin of a vehicle and an exterior-sensing sensor that senses exterior of the vehicle. Via processing of image data captured by the camera, the system determines an occupant action of an occupant of the vehicle that is indicative of an intention of the occupant to open a door of the vehicle. Via processing of sensor data captured by the exterior-sensing sensor, the system determines that an object exterior of the vehicle is likely to intersect a swing path of the door between a closed position and an opened position. The system may generate an alert to the occupant of the vehicle based on determining that the object is likely to intersect the swing path of the door.

### CROSS REFERENCE TO RELATED APPLICATION

The present application claims the filing benefits of U.S. provisional application Ser. No. 63/717,933, filed Nov. 8, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more exterior sensors at a vehicle.

### BACKGROUND OF THE INVENTION

Use of sensors in vehicle sensing systems is common and known. Such sensors are integrated at the vehicle and may sense areas rearward of the vehicle to assist the driver in reversing the vehicle.

### SUMMARY OF THE INVENTION

A vehicular sensing system includes a camera disposed at an interior portion of an interior cabin of a vehicle equipped with the vehicular sensing system. For example, the camera may include a driver monitoring camera and/or occupant monitoring camera and/or cabin monitoring camera. The camera views at least a portion of the interior cabin of the vehicle and is operable to capture image data. The camera includes an imager, and the imager includes a CMOS imaging array having at least one million photosensors arranged in rows and columns. An exterior-sensing sensor is disposed at the vehicle and senses exterior of the vehicle and is operable to capture sensor data. An electronic control unit (ECU) includes electronic circuitry and associated software. The electronic circuitry of the ECU includes an image processor for processing image data captured by the camera and transferred to the ECU and a data processor for processing sensor data captured by the exterior-sensing sensor and transferred to the ECU. The vehicular sensing system, via processing at the ECU of image data captured by the camera and transferred to the ECU, determines that an occupant of the vehicle intends to move a door of the vehicle from a closed position toward an opened position. The door, when opening or closing, moves along a swing path between the closed position and the opened position. The vehicular sensing system, via processing at the ECU of sensor data captured by the exterior-sensing sensor and transferred to the ECU, determines that an object exterior of the vehicle is likely to contact the door of the vehicle along the swing path. Based on determining that the object exterior of the vehicle is likely to contact the door of the vehicle along the swing path, and responsive to determining that the occupant of the vehicle intends to move the door of the vehicle from the closed position toward the opened position, the vehicular sensing system generates an alert to the occupant of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vehicular sensing system that utilizes sensors;

FIG. 2 is another plan view of the vehicle, showing a swing path of a door of the vehicle;

FIG. 3 is a schematic view of a first example scenario where another vehicle is parked within the swing path of the door of the vehicle;

FIG. 4 is a schematic view of a second example scenario where an approaching vehicle is travelling along a path of travel that is expected to intersect the swing path of the door of the vehicle; and

FIG. 5 is a schematic view of a third example scenario where an approaching bicycle is travelling along a path of travel that is expected to intersect the swing path of the door of the vehicle.

### DESCRIPTION OF THE PREFERRED EMBODIMENTS

A vehicle vision system and/or driver or driving assist system and/or object detection system and/or alert system operates to capture images and/or sensor data exterior of the vehicle and may process the captured image data and/or sensor data to display images and/or to detect objects at or near the vehicle and in the predicted path of the vehicle, such as to assist a driver of the vehicle in maneuvering the vehicle in a rearward direction during a parking maneuver. The vision system includes a data processor for processing captured sensor data and an image processor or image processing system that is operable to receive image data from one or more cameras and provide an output to a display device for displaying images representative of the captured image data. Optionally, the vision system may provide display, such as a rearview display or a top down or bird's eye or surround view display or the like.

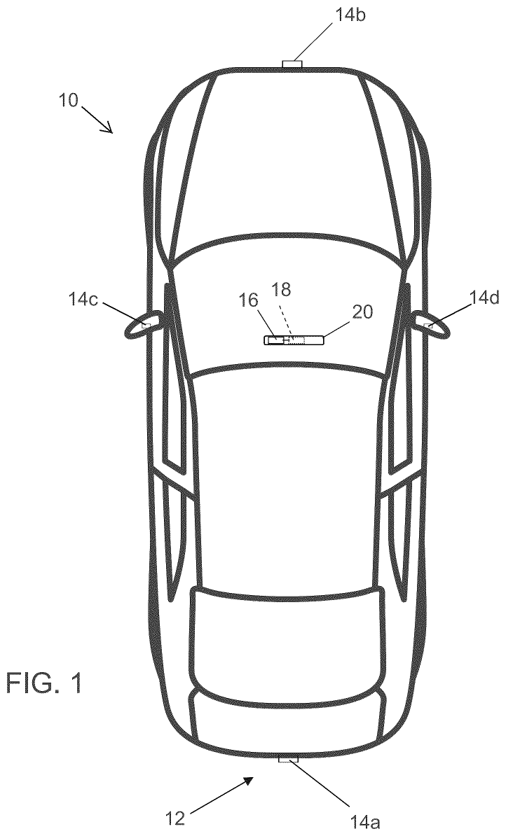

Referring now to the drawings and the illustrative embodiments depicted therein, a vehicle 10 includes a vehicular sensing system or imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

When operating in urban environments or tight spatial conditions, it may be dangerous to operate a vehicle door when there is an oncoming vehicle, bicycle, pedestrian and the like. For example, if the driver or vehicle occupant opens the vehicle door and contacts an approaching vehicle, bicycle or pedestrian, the vehicle door may be damaged and/or harm or damage may occur to the approaching obstacle. Further, damage may occur to the vehicle door if the driver or occupant opens the door into a static object, such as a wall or object not viewable through the vehicle window.

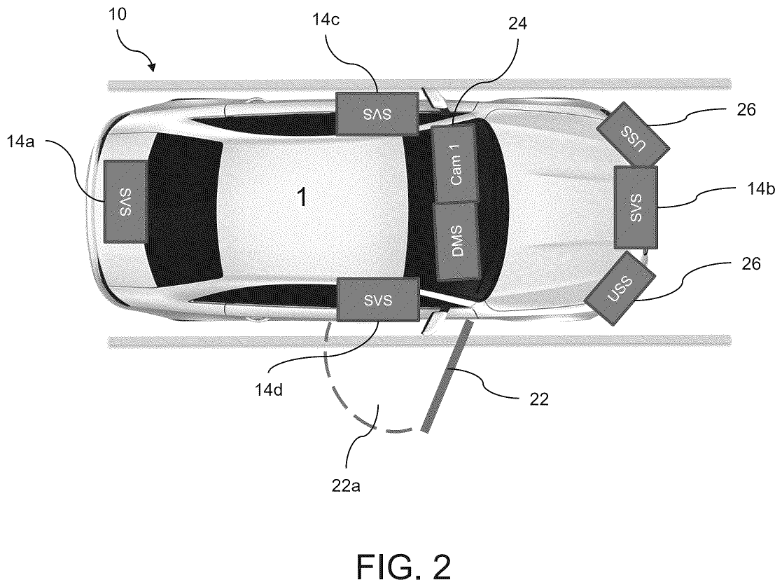

To prevent or preclude or reduce the chance of the driver and occupants from opening a door 22 of the vehicle 10 into a static or moving hazard, the driver assist system 12 determines presence of an object at or near or approaching a swing path or active area 22a of the door 22 and the system determines an occupant action indicating that the driver or occupant intends to or is in the process of opening the door 22 (FIG. 2). The swing path or active area 22a of the door 22 may comprise a region exterior of the vehicle that represents space occupied by the door 22 as it moves along its swing path between its closed position and its opened position. Based on determination of the object at or near or approaching the swing path 22a of the door 22 and responsive to determination that the driver or occupant intends to or is in the process of opening the door 22, the system 12 generates an alert to the driver or occupant and/or restricts movement of the door 22 along its swing path 22a.

As shown in FIG. 2, the exterior viewing cameras 14 of the vehicle 10 comprise part of a surround view system (SVS) that captures image data representative of the regions exterior of the vehicle 10, such as forward of the vehicle, along both sides of the vehicle, and rearward of the vehicle. The vehicle 10 further includes a driver monitoring system (DMS) and/or occupant monitoring system (OMS) having a camera 24 that views at least a portion of the interior cabin of the vehicle. The DMS/OMS camera 24 captures image data that is processed for monitoring the driver and/or occupants within the cabin of the vehicle, such as for monitoring hand positions of the driver and occupants (e.g., at interior door handles), for eye tracking or gaze detection or driver attentiveness and the like.

Moreover, the vehicle 10 may include a plurality of ultrasonic sensors 26 disposed at the vehicle 10 and configured to sense respective regions exterior of the vehicle 10. In the illustrated example, the vehicle 10 includes ultrasonic sensors 26 at the forward portion of the vehicle, such as at the front bumper or grille or front fascia of the vehicle, and configured to sense at least forward and/or sideward of the vehicle 10. Optionally, the vehicle 10 may include ultrasonic sensors 26 disposed at side portions of the vehicle 10, such as at or near the wheel wells or wheel arches of the vehicle 10, which may be configured to sense regions exterior of the vehicle extending sideward from the vehicle and at least along the respective sides of the vehicle. Ultrasonic sensors 26 may further be disposed at a rear portion of the vehicle 10, such as at or near a rear bumper of the vehicle 10, and may be configured to sense a region exterior of the vehicle and at least rearward and/or sideward of the vehicle.

Sensor data captured by exterior viewing sensors (e.g., the SVS cameras 14, the ultrasonic sensors 26, radar sensors and the like) may be processed to detect presence of objects at or near or approaching the swing path 22a of the door 22 and to determine whether the detected object is likely to contact the door 22. For example, the system 12 may detect presence of an object near the vehicle 10 and determine that the object is likely to contact the door 22 based on at least one of the object being present within the swing path 22a of the door 22, the object being present within a threshold distance of the swing path 22a of the door 22, an estimated path of travel of the object intersecting or coming within a threshold distance of the swing path 22a of the door 22 and the like.

Sensor data captured by interior viewing sensors (e.g., the DMS/OMS camera 24, radar sensors, a touch sensor at the interior door handle, a door open sensor and the like) may be processed to determine that the driver and/or occupant of the vehicle is opening the door 22 or intends to open the door 22. In other words, the system may determine behavior of the driver and/or occupant that is associated with the action of opening the door 22 or the intent of opening the door 22. For example, image data captured by the DMS/OMS camera 24 may be processed to detect presence of the driver's hand at or near an interior door handle assembly. Based on detecting presence of the driver's hand at or near the interior door handle assembly, the system 12 may determine that the driver intends to open the door 22. Optionally, the system 12 may determine that the driver is opening the door based on detection that the driver has operated the interior door handle assembly (e.g., by pulling the handle) to actuate a latch of the vehicle door and to move the door toward its opened position.

The system 12 may include one or more of the driver monitoring camera that views at least the driver region of the cabin of the vehicle, an occupant monitoring camera that views at least passenger regions of the cabin of the vehicle, and a cabin monitoring camera that views the driver region and the passenger regions of the cabin of the vehicle. Image data captured by the respective cameras may be processed for determining presence of the driver or passengers hands at the interior door handle of the door of the vehicle. That is, the image data captured by the driver monitoring camera may be processed for detecting the driver's hand at the interior door handle of the driver door of the vehicle, the image data captured by the occupant monitoring camera may be processed for detecting the passenger's hand at the interior door handle of the passenger door of the vehicle, and/or image data captured by the cabin monitoring camera may be processed for detecting the driver's hand at the interior door handle of the driver door of the vehicle and/or detecting the passenger's hand at the interior door handle of the passenger door of the vehicle.

The system 12 may begin processing sensor data captured by the exterior viewing sensors to monitor for nearby or approaching objects in response to the driver parking the vehicle 10. In other words, the system 12 may monitor for hazardous objects based on a gear selector of the vehicle being in a park position and/or the propulsion system of the vehicle being turned off. Optionally, the system 12 may begin monitoring for nearby or approaching objects in response to the vehicle 10 travelling below a threshold speed (e.g., below 10 miles per hour, below 5 miles per hour, and the like), in response to determination that the vehicle 10 is geographically located in a parking lot, a garage, a driveway, a street parking zone, a drop off zone or a loading zone (such as based on a signal from a GPS or navigation system of the vehicle), or in response to determining other conditions in which the door 22 is likely to be opened. Thus, the system 12 may detect approaching objects prior to the driver attempting to open the door and the system 12 may quickly react to the driver attempting to open the door based on determination that the object is likely to contact the door 22.

Optionally, the system 12 may begin processing sensor data to monitor for approaching objects responsive to determination that the driver is attempting to open the door 22. For example, based on detection of the driver's hand at or near the interior door handle and/or based on detection of the driver unlatching their seatbelt, the system 12 may process sensor data captured by the exterior viewing sensors to determine presence of hazardous objects at or near or approaching the door 22 or at or near or approaching the swing path 22a of the door 22.

Based on determining that the object is likely to contact the door 22 within its swing path 22a, and responsive to determining that the driver or occupant is likely to or currently is moving the door 22 from its closed position toward its opened position, the system 12 generates an alert to the driver or occupant so that the driver or occupant may cease opening the door 22 before it contacts the object. For example, the system 12 may generate an audible alert interior the vehicle, such as an audible tone or audio message played via a speaker or audio system of the vehicle 10. Optionally, the system 12 may generate an audible alert exterior of the vehicle 10 to alert the pedestrian or approaching object as to the potentially opening door. In some examples, the system 12 may generate a visual alert to the driver or occupant, such as by illuminating an icon at the exterior rearview mirror assembly (e.g., a backlit illuminable icon viewable at the glass of the mirror reflective element) at the gauge cluster of the vehicle, and the like. Optionally, the visual alert may include a warning message and/or video images representative of the detected obstacle that are provided to the driver or occupant at an infotainment screen of the vehicle (or other suitable display screen of the vehicle). Further, the video images may highlight or otherwise provide an overlay at the detected obstacle in the video images. The system 12 may similarly generate a visual alert that is viewable by the pedestrian or approaching object exterior the vehicle, such as by illuminating or flashing hazard lights of the vehicle, illuminating or flashing turn signals of the vehicle, illuminating or flashing tail lamps and/or head lamps of the vehicle, and the like.

Optionally, the system 12 may at least partially restrict movement of the door 22 toward its opened position based on detection of the obstacle at or near or approaching the swing path 22a of the door 22. For example, the system 12 may determine current positioning of the object relative to the swing path 22a of the door and/or an expected path of travel of the object relative to the swing path 22a of the door and restrict movement of the door 22 along its swing path 22a to the extent necessary to prevent the door 22 from contacting the obstacle. In some examples, the system 12 may temporarily restrict the door 22 from opening, such as by preventing the door latch from releasing the door from the closed position. The system 12 may allow the door 22 to move toward its opened position after determining that the obstacle is not likely to contact the door (e.g., the obstacle moves past the vehicle) or based on an override by the driver or occupant (e.g., a second actuation of the door handle). In other words, any mechanism to restrict operation of the door may be easily overridden by the occupant.

Thus, sensor data from a combination of a vehicle's camera-based DMS, SVS and ultrasonic sensors (USS) may be used to detect when a driver or occupant intends to open a vehicle door and also when a potential hazard is present exterior the vehicle. When behavior of the vehicle driver and/or occupant is determined to indicate an intention to open the door and a hazard is present, the system may provide an audible warning of the hazard, provide a visual warning (e.g., on the vehicle rearview mirror and/or in-vehicle infotainment, such as an indicator or obstacle highlight in video images), and/or restrict operation of the door in an attempt to actively avoid the hazard. For example, a mechanism may restrict operation of the door and may be easily overridden by the driver and/or occupant. In some examples, the DMS may monitor the position of the driver and/or occupant and predict when the user intends to open the door, such as based on detected hand positions. When it is determined that the door is intended to be opened, any detected potential hazards may be communicated to the driver or occupant. Optionally, a door open sensor may be leveraged to trigger potential hazard warnings.

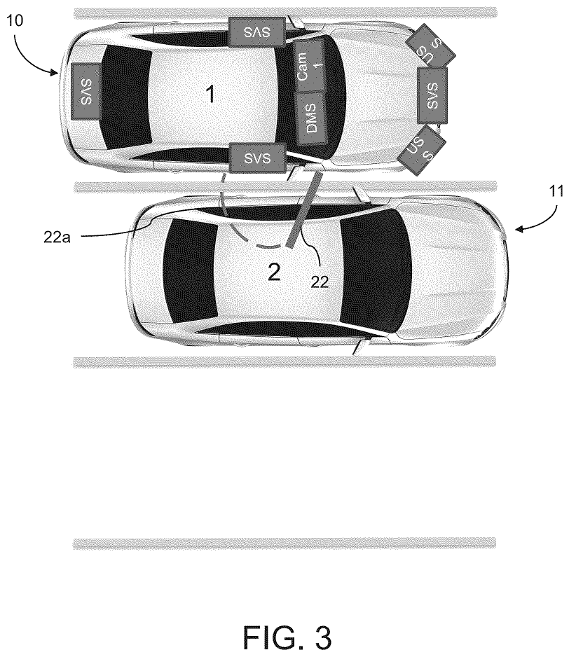

Referring to FIG. 3, a first example scenario includes a static object, such as another vehicle 11, that is disposed within the swing path 22a of the door 22 of the vehicle 10 when the vehicle 10 is parked. In other words, the other vehicle 11 is parked within reach of the door 22 of the vehicle 10. Based on detection of the other vehicle 11, the system 12 may restrict operation of the door 22 to avoid contacting the other vehicle 11. That is, the system 12 may restrict movement of the door 22 along its swing path 22a so that the door 22 may open only until a point before the door 22 contacts the other vehicle 11. Optionally, the system 12 may prevent the door 22 from opening at all.

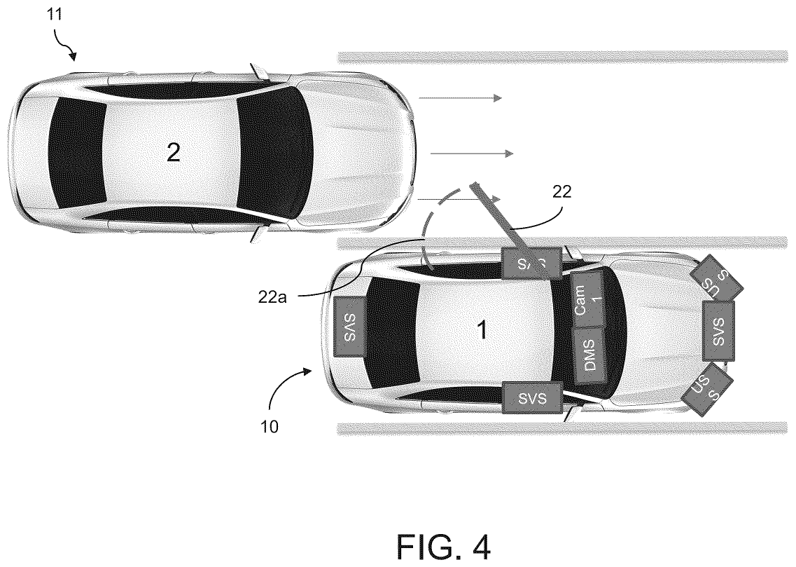

Referring to FIG. 4, a second example scenario includes a moving object, such as the other vehicle 11, that is moving toward or approaching the swing path 22a of the door 22 of the vehicle 10 when the vehicle 10 is parked. That is, the vehicle 10 is parked and the driver may attempt to exit the vehicle 10 with the other vehicle 11 oncoming such that the path of travel of the other vehicle 11 may intrude into or come within a threshold distance (e.g., one foot, three feet, five feet, and the like) of the swing path 22a of the door 22. Based on detection of the other vehicle 11 and determination that the other vehicle 11 is likely to intersect the swing path 22a of the door 22, and responsive to determination that the driver intends to open the door 22, the warning is displayed to the driver and door usage may be restricted until the other vehicle 11 passes.

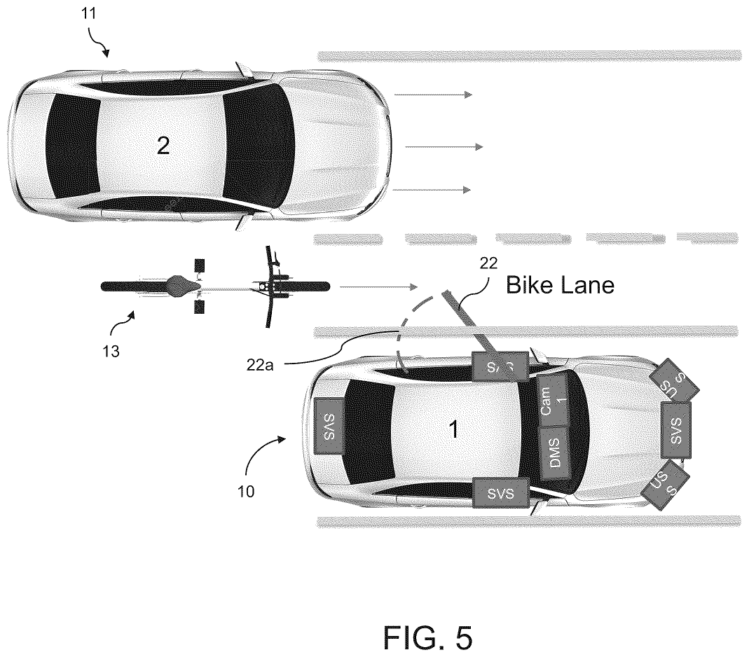

Referring to FIG. 5, a third example scenario includes a first moving object, such as the other vehicle 11 that is moving toward the vehicle 10, and a second moving object, such as a bicycle 13, that is moving toward the swing path 22a of the door 22 of the vehicle 10 when the vehicle 10 is parked. In other words, the vehicle 10 is parked and the driver may attempt to exit the vehicle 10 with the other vehicle 11 oncoming such that the path of travel of the other vehicle 11 is unlikely to intersect the swing path 22a of the door 22 and the bicycle 13 oncoming such that the path of travel of the bicycle 13 may intrude into or come within a threshold distance of the swing path 22a of the door 22. The system 12 may detect the other vehicle 11 and not generate an alert because the path of travel of the other vehicle 11 is determined to not intersect the swing path 22a of the door 22. Based on detection of the bicycle 13 and determination that the bicycle 13 is likely to intersect the swing path 22a of the door 22, and responsive to determination that the driver intends to open the door 22, the warning is displayed to the driver and door usage may be restricted until the bicycle 13 passes.

Optionally, the vehicular sensing system may utilize characteristics of the vehicular sensing and door opening control systems described in U.S. Pat. Nos. 12,030,513; 11,124,113; 9,688,199 and/or 9,068,390 and/or U.S. Publication No. US-2023-0032998, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The imaging device and control and image processor and any associated illumination source, if applicable, may comprise any suitable components, and may utilize aspects of the cameras (such as various imaging sensors or imaging array sensors or cameras or the like, such as a CMOS imaging array sensor, a CCD sensor or other sensors or the like) and vision systems described in U.S. Pat. Nos. 5,760,962; 5,715,093; 6,922,292; 6,757,109; 6,717,610; 6,590,719; 6,201,642; 5,796,094; 6,559,435; 6,831,261; 6,822,563; 6,946,978; 7,720,580; 8,542,451; 7,965,336; 7,480,149; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2009/036176; WO 2009/046268; WO 2010/099416; WO 2011/028686 and/or WO 2013/016409, and/or U.S. Publication Nos. US 2010-0020170 and/or US-2009-0244361, which are all hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2020-0039447; US-2015-0327398; US-2015-0015713; US-2014-0160284; US-2014-0226012 and/or US-2009-0295181, which are all hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The ECU may be operable to process data for at least one driving assist system of the vehicle. For example, the ECU may be operable to process data (such as image data captured by a forward viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process radar data captured by a radar sensor of the vehicle or other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 19/290,465, filed Aug. 5, 2025 (Attorney Docket DON01 P5440), and/or International Publication No. WO 2023/220222 and/or International PCT Application No. PCT/US 2025/038021, filed Jul. 17, 2025 (Attorney Docket DON01 FP5398WO), and/or International Patent Application Ser. No. PCT/US 25/27206, filed May 1, 2025 (Attorney Docket MAG04 FP5372WO), which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US- 2024-0064274; US-2021-0245662; US-2021-0162926; US-2021-0155167 and/or US-2019-0118717, which are all hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Optionally, the display may be viewable through a reflective element of a mirror assembly when the display is activated to display information. Optionally, the display element may comprise any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like.

The display device may be disposed at or incorporated in an interior mirror assembly, and the interior mirror assembly may comprise a dual-mode interior rearview video mirror that can switch from a traditional reflection mode to a live-video display mode, such as by utilizing aspects of the mirror assemblies and systems described in U.S. Pat. Nos. 10,442,360; 10,421,404; 10,166,924 and/or 10,046,706, and/or U.S. Publication Nos. US-2021-0323473; US-2021-0245662; US-2021-0162926; US-2021-0155167; US-2021-0094473; US-2020-0377022; US-2019-0258131; US-2019-0146297; US-2019-0118717; US-2019-0047475 and/or US-2017-0355312, which are all hereby incorporated herein by reference in their entireties. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

Optionally, the exterior rearview mirror assembly may include an indicator for alerting the driver or occupant attempting to open the door, such as an indicator or indicators of the types described in U.S. Pat. Nos. 8,242,896; 7,492,281; 6,198,409; 5,929,786 and/or 5,786,772, which are hereby incorporated herein by reference in their entireties. The signal indicator or indication module may include or utilize aspects of various light modules or systems or devices, such as the types described in U.S. Pat. Nos. 8,764,256; 7,626,749; 7,581,859; 6,227,689; 6,582,109; 5,371,659; 5,497,306; 5,669,699; 5,823,654; 6,176,602 and/or 6,276,821, and/or U.S. Publication No. US-2013-0242586, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a camera disposed at an interior portion of an interior cabin of a vehicle equipped with the vehicular sensing system, wherein the camera views at least a portion of the interior cabin of the vehicle, and wherein the camera is operable to capture image data;
wherein the camera comprises an imager, and wherein the imager comprises an imaging array having at least one million photosensors arranged in rows and columns;
an exterior-sensing sensor disposed at the vehicle and sensing exterior of the vehicle, wherein the exterior-sensing sensor is operable to capture sensor data;
an electronic control unit (ECU);
wherein image data captured by the camera is transferred to the ECU, and wherein sensor data captured by the exterior-sensing sensor is transferred to the ECU;
wherein the ECU comprises electronic circuitry and associated software;
wherein the electronic circuitry of the ECU comprises at least one data processor for (i) processing image data captured by the camera and transferred to the ECU and (ii) processing sensor data captured by the exterior-sensing sensor and transferred to the ECU;
wherein the vehicular sensing system, via processing at the ECU of image data captured by the camera and transferred to the ECU, determines an occupant action of an occupant of the vehicle that is indicative of an intention of the occupant to open a door of the vehicle;
wherein the door moves along a swing path when moving between a closed position and an opened position; and
wherein the vehicular sensing system, via processing at the ECU of sensor data captured by the exterior-sensing sensor and transferred to the ECU, determines that an object exterior of the vehicle is likely to intersect the swing path of the door.

2. The vehicular sensing system of claim 1, wherein the camera comprises a driver monitoring camera, and wherein the driver monitoring camera views at least a driver region within the interior cabin of the vehicle, and wherein the occupant of the vehicle comprises a driver of the vehicle.

3. The vehicular sensing system of claim 2, wherein the vehicular sensing system determines the occupant action based on detecting, via processing at the ECU of image data captured by the driver monitoring camera and transferred to the ECU, presence of a hand of the driver at an interior door handle assembly associated with the door of the vehicle.

4. The vehicular sensing system of claim 1, wherein the camera comprises an occupant monitoring camera, and wherein the occupant monitoring camera views at least a passenger region within the interior cabin of the vehicle, and wherein the occupant of the vehicle comprises a passenger of the vehicle.

5. The vehicular sensing system of claim 4, wherein the vehicular sensing system determines the occupant action based on detecting, via processing at the ECU of image data captured by the occupant monitoring camera and transferred to the ECU, presence of a hand of the passenger at an interior door handle assembly associated with the door of the vehicle.

6. The vehicular sensing system of claim 1, wherein the camera comprises a cabin monitoring camera, and wherein the cabin monitoring camera views at least a driver region within the interior cabin of the vehicle and a passenger region within the interior cabin of the vehicle, and wherein the occupant of the vehicle comprises at least one selected from the group consisting of (i) a driver of the vehicle and (ii) a passenger of the vehicle.

7. The vehicular sensing system of claim 6, wherein the vehicular sensing system determines the occupant action based on at least one selected from the group consisting of (i) detecting, via processing at the ECU of image data captured by the cabin monitoring camera and transferred to the ECU, presence of a hand of the driver at an interior door handle assembly associated with a driver door of the vehicle and (ii) detecting, via processing at the ECU of image data captured by the cabin monitoring camera and transferred to the ECU, presence of a hand of the passenger at an interior door handle assembly associated with a passenger door of the vehicle.

8. The vehicular sensing system of claim 1, wherein the exterior-sensing sensor comprises one or more exterior-viewing cameras that view respective regions exterior of the vehicle.

9. The vehicular sensing system of claim 1, wherein the exterior-sensing sensor comprises one or more ultrasonic sensors that sense respective regions exterior of the vehicle.

10. The vehicular sensing system of claim 1, wherein the exterior-sensing sensor comprises one or more radar sensors that sense respective regions exterior of the vehicle.

11. The vehicular sensing system of claim 1, wherein, based on determining that the object exterior of the vehicle is likely to intersect the swing path of the door, and responsive to determining the occupant action, the vehicular sensing system generates an alert to the occupant of the vehicle, and wherein the alert comprises at least one selected from the group consisting of (i) an audio tone played within the interior cabin of the vehicle, (ii) an illuminated icon at an exterior rearview mirror assembly at a side of the vehicle corresponding to the door of the vehicle and (iii) video images that are displayed at a display screen within the interior cabin of the vehicle and that are representative of the object exterior of the vehicle.

12. The vehicular sensing system of claim 1, wherein the vehicular sensing system determines that the object exterior of the vehicle is likely to intersect the swing path of the door based on at least one selected from the group consisting of (i) determination that the object is present within the swing path, (ii) determination that the object is present within a threshold distance of the swing path and (iii) determination that the object is moving along a path of travel that intersects the swing path of the door.

13. A vehicular sensing system, the vehicular sensing system comprising:
a driver monitoring camera disposed at an interior portion of an interior cabin of a vehicle equipped with the vehicular sensing system, wherein the driver monitoring camera views at least a driver region within the interior cabin of the vehicle, and wherein the driver monitoring camera is operable to capture image data;
wherein the driver monitoring camera comprises an imager, and wherein the imager comprises an imaging array having at least one million photosensors arranged in rows and columns;
an exterior-sensing sensor disposed at the vehicle and sensing exterior of the vehicle, wherein the exterior-sensing sensor is operable to capture sensor data;
an electronic control unit (ECU);
wherein image data captured by the driver monitoring camera is transferred to the ECU, and wherein sensor data captured by the exterior-sensing sensor is transferred to the ECU;
wherein the ECU comprises electronic circuitry and associated software;
wherein the electronic circuitry of the ECU comprises at least one data processor for (i) processing image data captured by the driver monitoring camera and transferred to the ECU and (ii) processing sensor data captured by the exterior-sensing sensor and transferred to the ECU;
wherein the vehicular sensing system, via processing at the ECU of image data captured by the driver monitoring camera and transferred to the ECU, determines a driver action of a driver of the vehicle that is indicative of an intention of the driver to open a door of the vehicle;
wherein the door moves along a swing path when moving between a closed position and an opened position;
wherein the vehicular sensing system, via processing at the ECU of sensor data captured by the exterior-sensing sensor and transferred to the ECU, determines that an object exterior of the vehicle is likely to intersect the swing path of the door; and
wherein, based on determining that the object exterior of the vehicle is likely to intersect the swing path of the door, and responsive to determining the driver action, the vehicular sensing system generates an alert to the driver of the vehicle.

14. The vehicular sensing system of claim 13, wherein the vehicular sensing system determines the driver action based on detecting, via processing at the ECU of image data captured by the driver monitoring camera and transferred to the ECU, presence of a hand of the driver at an interior door handle assembly associated with the door of the vehicle.

15. The vehicular sensing system of claim 13, wherein the exterior-sensing sensor comprises at least one selected from the group consisting of (i) one or more exterior-viewing cameras that view respective regions exterior of the vehicle, (ii) one or more ultrasonic sensors that sense respective regions exterior of the vehicle and (iii) one or more radar sensors that sense respective regions exterior of the vehicle.

16. The vehicular sensing system of claim 13, wherein the alert comprises at least one selected from the group consisting of (i) an audio tone played within the interior cabin of the vehicle, (ii) an illuminated icon at an exterior rearview mirror assembly at a side of the vehicle corresponding to the door of the vehicle and (iii) video images that are displayed at a display screen within the interior cabin of the vehicle and that are representative of the object exterior of the vehicle.

17. The vehicular sensing system of claim 13, wherein the vehicular sensing system determines that the object exterior of the vehicle is likely to intersect the swing path of the door based on at least one selected from the group consisting of (i) determination that the object is present within the swing path, (ii) determination that the object is present within a threshold distance of the swing path and (iii) determination that the object is moving along a path of travel that intersects the swing path of the door.

18. A vehicular sensing system, the vehicular sensing system comprising:
a cabin monitoring camera disposed at an interior portion of an interior cabin of a vehicle equipped with the vehicular sensing system, wherein the cabin monitoring camera views at least a driver region within the interior cabin of the vehicle and a passenger region within the interior cabin of the vehicle, and wherein the cabin monitoring camera is operable to capture image data;
wherein the cabin monitoring camera comprises an imager, and wherein the imager comprises an imaging array having at least one million photosensors arranged in rows and columns;
an exterior-sensing sensor disposed at the vehicle and sensing exterior of the vehicle, wherein the exterior-sensing sensor is operable to capture sensor data;
an electronic control unit (ECU);
wherein image data captured by the cabin monitoring camera is transferred to the ECU, and wherein sensor data captured by the exterior-sensing sensor is transferred to the ECU;
wherein the ECU comprises electronic circuitry and associated software;
wherein the electronic circuitry of the ECU comprises at least one data processor for (i) processing image data captured by the cabin monitoring camera and transferred to the ECU and (ii) processing sensor data captured by the exterior-sensing sensor and transferred to the ECU;
wherein the vehicular sensing system, via processing at the ECU of image data captured by the cabin monitoring camera and transferred to the ECU, determines an occupant action of an occupant of the vehicle that is indicative of an intention of the occupant to open a door of the vehicle;
wherein the occupant of the vehicle comprises at least one selected from the group consisting of (i) a driver of the vehicle and (ii) a passenger of the vehicle;
wherein the vehicular sensing system determines the occupant action based on at least one selected from the group consisting of (i) detecting, via processing at the ECU of image data captured by the cabin monitoring camera and transferred to the ECU, presence of a hand of the driver at an interior door handle assembly associated with a driver door of the vehicle and (ii) detecting, via processing at the ECU of image data captured by the cabin monitoring camera and transferred to the ECU, presence of a hand of the passenger at an interior door handle assembly associated with a passenger door of the vehicle;
wherein the door moves along a swing path when moving between a closed position and an opened position;
wherein the vehicular sensing system, via processing at the ECU of sensor data captured by the exterior-sensing sensor and transferred to the ECU, determines that an object exterior of the vehicle is likely to intersect the swing path of the door; and
wherein, based on determining that the object exterior of the vehicle is likely to intersect the swing path of the door, and responsive to determining the occupant action, the vehicular sensing system generates an alert to the occupant of the vehicle.

19. The vehicular sensing system of claim 18, wherein the exterior-sensing sensor comprises at least one selected from the group consisting of (i) one or more exterior-viewing cameras that view respective regions exterior of the vehicle, (ii)one or more ultrasonic sensors that sense respective regions exterior of the vehicle and (iii) one or more radar sensors that sense respective regions exterior of the vehicle.

20. The vehicular sensing system of claim 18, wherein the vehicular sensing system determines that the object exterior of the vehicle is likely to intersect the swing path of the door based on at least one selected from the group consisting of (i) determination that the object is present within the swing path, (ii) determination that the object is present within a threshold distance of the swing path and (iii) determination that the object is moving along a path of travel that intersects the swing path of the door.
